(19) United States
(12) Patent Application Publication
(10) Pub. No.: US 2014/0168519 A1
(43) Pub. Date: Jun. 19, 2014

(54) TUNER MODULE AND RECEIVING APPARATUS

(71) Applicants: Tadashi Imai, Kanagawa (JP); Hideaki Ozawa, Chiba (JP); Toshiyuki Nagano, Kanagawa (JP); Teruyuki Toyoda, Tokyo (JP); Tomonori Nakajima, Tokyo (JP); Mitsuru Ikeda, Tokyo (JP); Goujin Arakawa, Kanagawa (JP); Toshiyuki Sudo, Tokyo (JP); Norio Uchida, Kanagawa (JP); Hiroyuki Takamatsu, Kanagawa (JP)

(72) Inventors: Tadashi Imai, Kanagawa (JP); Hideaki Ozawa, Chiba (JP); Toshiyuki Nagano, Kanagawa (JP); Teruyuki Toyoda, Tokyo (JP); Tomonori Nakajima, Tokyo (JP); Mitsuru Ikeda, Tokyo (JP); Goujin Arakawa, Kanagawa (JP); Toshiyuki Sudo, Tokyo (JP); Norio Uchida, Kanagawa (JP); Hiroyuki Takamatsu, Kanagawa (JP)

(73) Assignee: Sony Corporation, Tokyo (JP)

(21) Appl. No.: 14/235,314

(22) PCT Filed: Jul. 25, 2012
(86) PCT No.: PCT/JP2012/068805

§ 371 Date: Jan. 27, 2014

(30) Foreign Application Priority Data
Aug. 4, 2011 (JP) 2011-171343

(51) Int. Cl. H04N 5/50

(52) U.S. Cl. CPC H04N 5/50
USPC 348/731

(57) ABSTRACT

There is provided a tuner module of the present disclosure includes a tuner module board on which a tuner function unit is formed, a case body that holds at least the tuner module board so as to contain the board, and at least one antenna connector fixed to the case body and whose core wire is connected to the tuner module board contained in the case body.

### TECHNICAL FIELD

The present disclosure relates to a tuner module and a receiving apparatus and, in particular, relates to a technology to slim down a tuner module.

### BACKGROUND ART

In recent years, a television (TV) tuner as an example of a high-frequency module is contained not only in TV sets, but also in IT devices such as personal computers (PC). Such TV and PC enhance convenience by miniaturization and slimming down and slimming down of module tuners has become an important subject.

For example, a first example is shown in Patent Literature 1 and a second example is shown in Patent Literature 2 as examples showing the shape of a TV tuner and its implementation method.

The first example is configured to have features that the outer shape of a chassis contact surface on which an input connector (antenna connector) is mounted is thicker than a chassis angle portion.

The shape thereof is optimized for the purpose of slimming down a cabinet of the tuner unit and a structure in which the thicknesses thereof are decided based on the outside diameter of the input connector is adopted.

In the second example, a structure in which a lower portion of an input connector mounting portion is brought into contact with a circuit board on which a tuner is mounted and at the same time, another leg portion to be brought into contact with the circuit board in the same height is combined for mounting is described.

According to this method, the thickness of the tuner is also decided generally based on the outside diameter of the input connector.

### CITATION LIST

### Patent Literature

Patent Literature 1: JP 3411461B1

Patent Literature 2: JP 2004-229212A

### SUMMARY OF INVENTION

### Technical Problem

However, the first example is structured such that a mounting portion of the input connector and the chassis angle portion are simultaneously fixed by being covered with a common cover as an upper surface and a lower surface.

In this case, if the surface of the cover constituting a uniform surface is considered as a reference, even if the thickness of a circumscribing portion of the input connector and the chassis angle portion is enormously increased, it is unavoidable to set the height thereof to a height approximately equal to the dimension of the circumscribing portion of the input connector with a larger thickness after being covered with the cover.

Therefore, the configuration is such that the thickness of the whole tuner can be made slightly smaller than the outside diameter of the input connector or the thickness can hardly be slimmed down with a cover.

Further, the second example is structured to have a tuner and a board on which the tuner is mounted and thus, the thickness of the circuit board is added to the thickness of the tuner unit. That is, the structure is such that the thickness approximately equal to the outside diameter of the input connector is added to the thickness of the circuit board.

Similarly in this case, the thickness of the whole tuner can be realized only as a tuner of the thickness approximately equal to the outside diameter of the input connector and further, the tuner in this shape is configured to be mounted on the circuit board and thus, the structure has the final thickness obtained by further adding the thickness of the circuit board, imposing limits on slimming own.

In a tuner structure using conventional technology, as described above, a structure in which a tuner is mounted on a circuit board is adopted and thus, the thickness of the tuner is purely added to the thickness of the circuit board.

Therefore, it is easily understandable from the above two literatures that when slimming down the thickness dimension of the tuner unit, the thickness of the input connector fixed to the tuner unit becomes the lower limit.

In liquid crystal TV particularly slimmed down in recent years, the height of such a tuner has become a size that cannot be ignored.

In a mounting structure of a tuner mounted on a board, it can easily be expected that the center of an input connector portion to which an input cable from an antenna is connected is arranged in an offset position from a middle point of the added thickness of the circuit board and the tuner.

In this case, a problem of a narrower space for work when actually a TV cable is connected is likely to occur.

The present invention is intended to drastically slim down the thickness dimension of a whole receiving apparatus in a wide range when a tuner module is mounted on the apparatus.

### Solution to Problem

One aspect of a tuner module of the present disclosure includes a tuner module board on which a tuner function unit is formed, a case body that holds at least the tuner module board so as to contain the board, and at least one antenna connector fixed to the case body and whose core wire is connected to the tuner module board contained in the case body.

A fixing portion and a sandwiching portion in a convex shape are formed on a joint of the antenna connector to the case body.

The case body has at least a horizontal surface and a vertical surface with respect to the tuner module board, and the vertical surface has one insertion hole or more into which the core wire and the fixing portion of the antenna connector are inserted.

Then, when the core wire and the fixing portion of the antenna connector are inserted into the insertion hole of the case body, a portion on the vertical surface of the case body between the insertion hole and the horizontal surface is sandwiched between the fixing portion and the sandwiching portion of the antenna connector.

Another aspect of a tuner module of the present disclosure includes, like the above case, a tuner module board, a case body, and an antenna connector.

A fixing portion in a convex shape is formed on a joint of the antenna connector to the case body.

The case body has at least a horizontal surface and a vertical surface with respect to the tuner module board and the vertical surface has one insertion hole or more into which the core wire and the fixing portion of the antenna connector are inserted formed therein.

Then, the core wire and the fixing portion of the antenna connector are inserted into the insertion hole of the case body and the fixing portion of the antenna connector is caulked by the insertion hole formed on the vertical surface of the case body.

According to the one aspect and the other aspect of the present disclosure, the core wire and the fixing portion of the joint of the antenna connector are inserted into the case body and the fixing portion of the antenna connector is fixed to the insertion hole formed on the vertical surface of the case body by caulking. Accordingly, a height of the case body can be formed with the height lower than the height of the antenna connector. Then, a thickness dimension of the whole case body excluding a neighborhood of the joint of the case body to the antenna connector.

### Advantageous Effects of Invention

According to the present disclosure, when a tuner module is mounted on a receiving apparatus, the thickness dimension of the whole apparatus is drastically slimmed down in a wide range by mounting the tuner module on the receiving apparatus such that, for example, only an antenna connector is exposed to the outside of the receiving apparatus.

### BRIEF DESCRIPTION OF DRAWINGS

FIG. 1 is a perspective view showing a configuration example when viewed from a top surface side of a tuner module according to a first embodiment of the present disclosure.

FIG. 2 is an exploded perspective view showing the configuration example when viewed from the top surface side of the tuner module according to the first embodiment of the present disclosure.

FIG. 3 is an exploded perspective view showing the configuration example when viewed from another direction of the top surface side of the tuner module according to the first embodiment of the present disclosure.

FIG. 4 is a perspective view showing the configuration example when principal units of the tuner module according to the first embodiment of the present disclosure are viewed from the top surface side.

FIG. 5 is a schematic sectional view showing the configuration example of the tuner module according to the first embodiment of the present disclosure.

FIG. 6 is a diagram showing a configuration example of a receiving apparatus adopting the tuner module according to the present embodiment.

FIG. 7 is a plan view showing a configuration example of a circuit board on which the tuner module according to the present embodiment is implemented.

FIG. 8 is a front view and a side view of a configuration example of a television set (an example of the receiving apparatus) including the circuit board on which the tuner module according to the present embodiment is implemented.

FIG. 9 is a schematic sectional view of the configuration example of the television set (an example of the receiving apparatus) including the circuit board on which the tuner module according to the present embodiment is implemented.

FIG. 10 is a perspective view showing a configuration example when viewed from the top surface side of a tuner module according to a second embodiment of the present disclosure.

FIG. 11 is an exploded perspective view showing the configuration example when viewed from the top surface side of the tuner module according to the second embodiment of the present disclosure.

FIG. 12 is a perspective view showing the configuration example when viewed from a bottom surface side of the tuner module according to the second embodiment of the present invention.

FIG. 13 is a perspective view showing a configuration example when viewed from the top surface side of a tuner module according to a modification of the second embodiment of the present disclosure.

FIG. 14 is a schematic sectional view showing the configuration example of the tuner module according to the second embodiment of the present disclosure.

### DESCRIPTION OF EMBODIMENTS

Hereinafter, embodiments of the present disclosure will be described in detail with reference to the appended drawings. Note that, in this specification and the drawings, elements that have substantially the same function and structure are denoted with the same reference signs, and repeated explanation is omitted.

The description will be provided in the following order:

1. First Embodiment (Tuner Case: Example Having Bending Portion)

1-1. Configuration Example of Tuner Module

1-2. Configuration Example of Receiving Apparatus

1-3. Example Applied to Television Set

2. Second Embodiment (Tuner Case: Example of Shape in which Height of Connector Connection Portion is Made Lower than Height of Antenna Connector)

### 1. First Embodiment

### 1-1. Configuration Example of Tuner Module

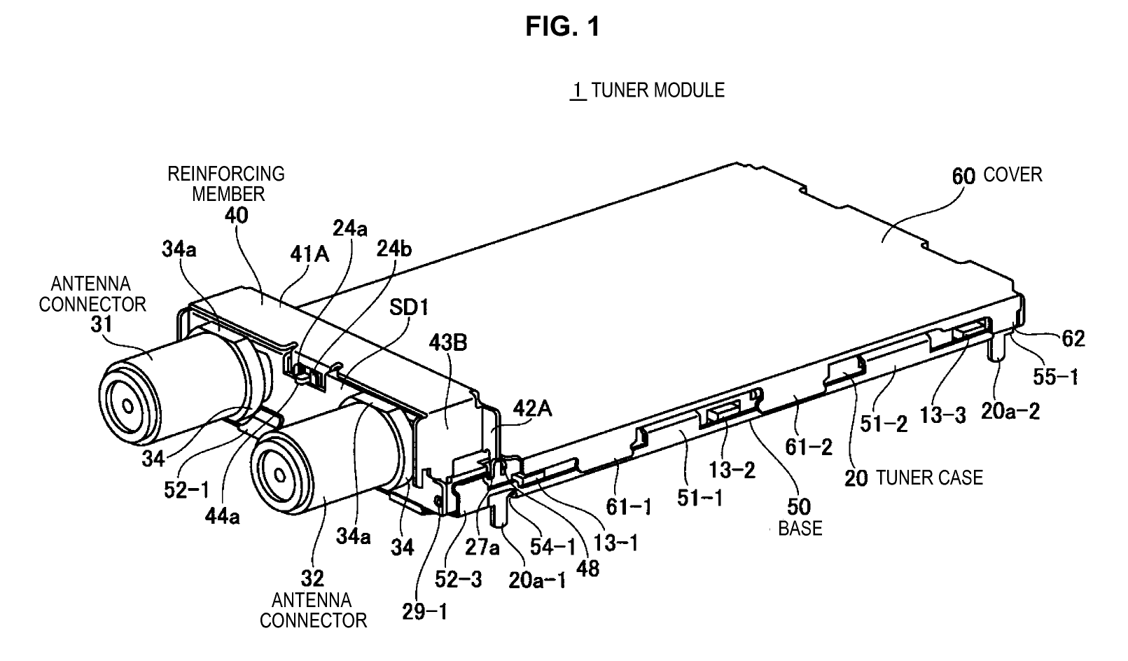

A tuner module according to the first embodiment of the present disclosure will be described with reference to FIGS. 1 to 5.

FIG. 1 is a perspective view showing a configuration example when viewed from a top surface side of a tuner module according to the first embodiment of the present disclosure.

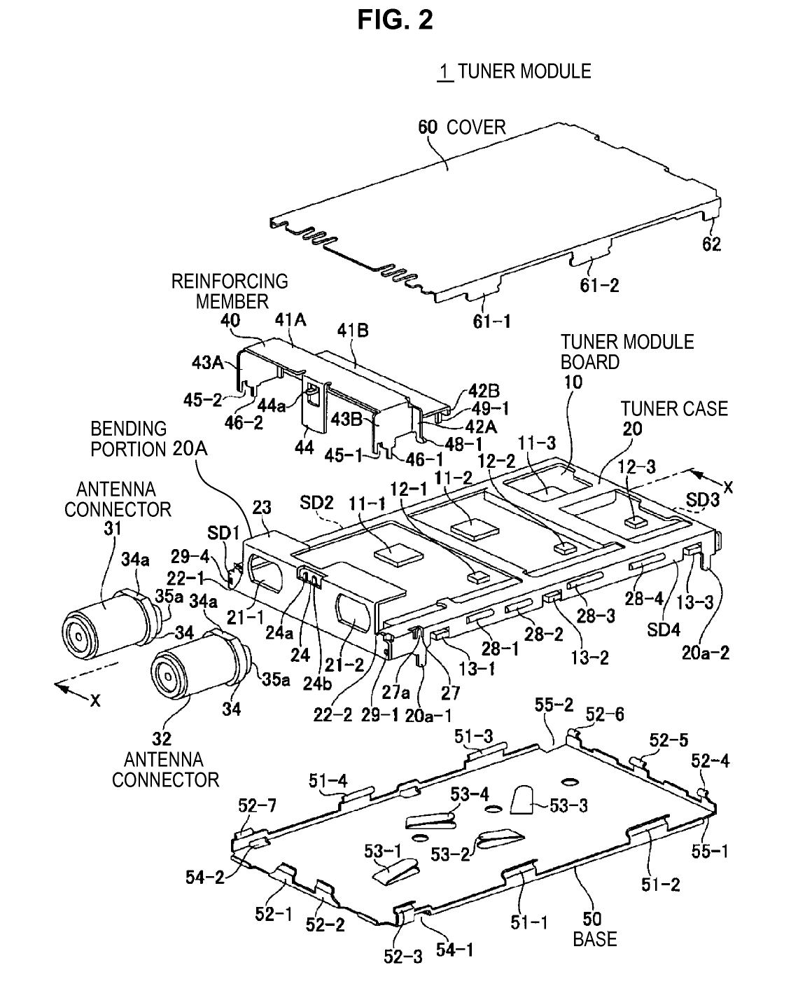

FIG. 2 is an exploded perspective view showing the configuration example when viewed from the top surface side of the tuner module according to the first embodiment of the present disclosure.

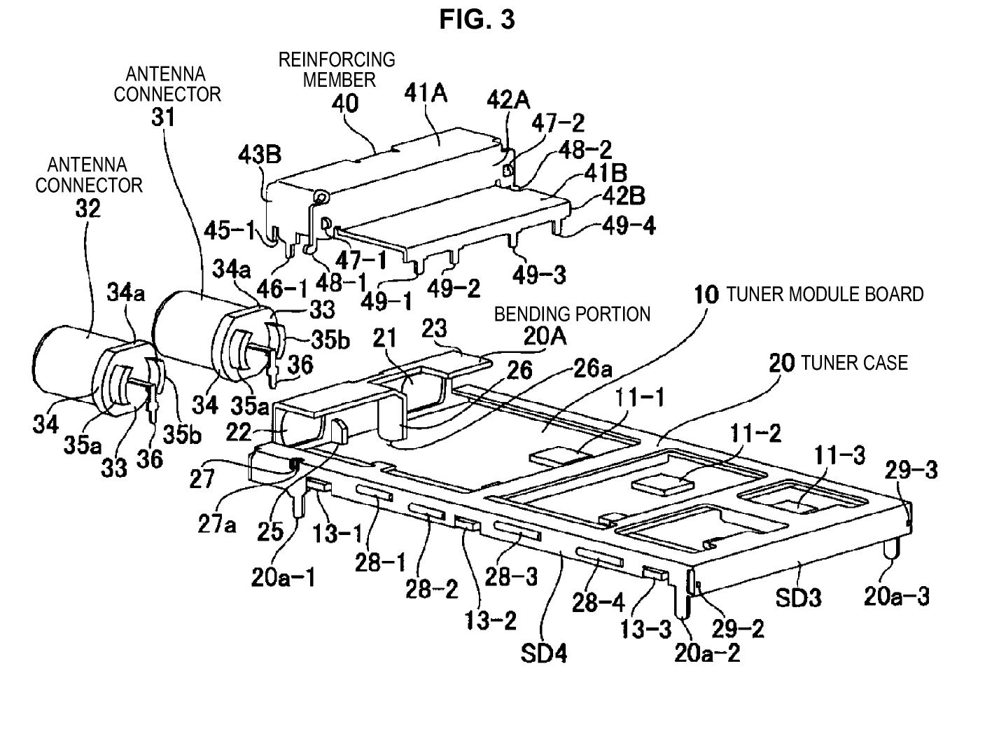

FIG. 3 is an exploded perspective view showing the configuration example when viewed from another direction of the top surface side of the tuner module according to the first embodiment of the present disclosure.

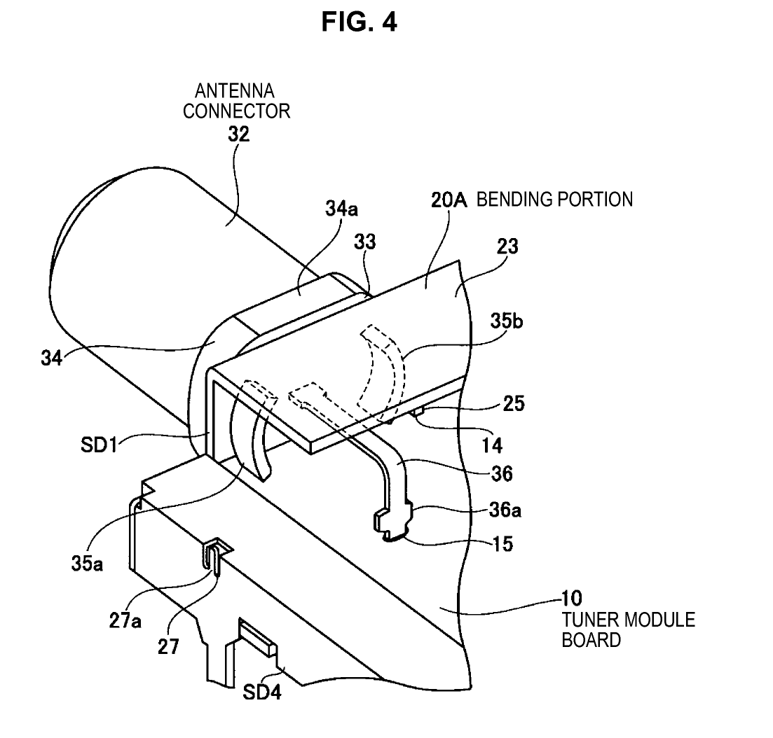

FIG. 4 is a perspective view showing the configuration example when principal units of the tuner module according to the first embodiment of the present disclosure are viewed from the top surface side.

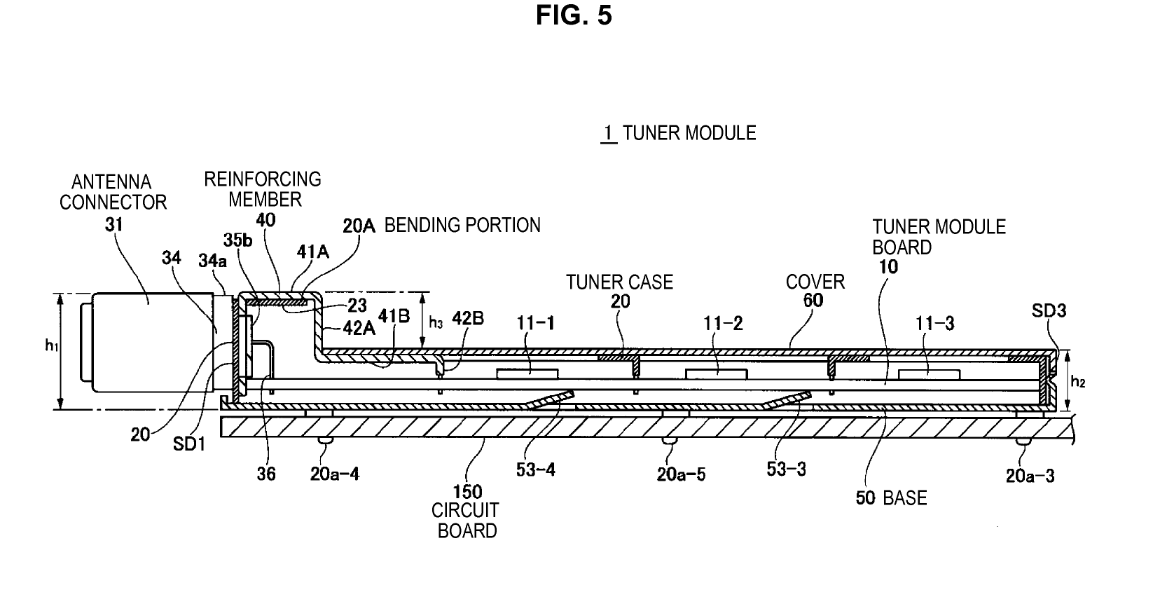

FIG. 5 is a schematic sectional view (X-X line section) showing the configuration example of the tuner module according to the first embodiment of the present disclosure.

The first embodiment is an example of a structure in which a bending portion to be a connection portion to an antenna connector is formed in a tuner case constituting a tuner module and portions other than the bending portion of the tuner case are lower than the height (outside diameter) of the antenna connector.

A tuner module 1 according to the first embodiment includes a tuner module board 10 (also called simply as a “board”) on which a tuner function unit is formed and a tuner case 20 (case body) holding the tuner module board 10 as if to contain the board and having a function as a shield case.

The tuner module 1 also includes two antenna connectors 31, 32 fixed to the tuner case 20 and whose core wire 36 is connected to the tuner module board 10 contained in the tuner case 20. The antenna connectors 31, 32 have an approximately cylindrical shape and an antenna cable is connected to one bottom portion and the other bottom portion (joint 33) is joined to the tuner case 20.

The tuner case 20 is arranged on a base 50 and an upper portion thereof is covered with a cover 60 as a structure to protect the tuner module board 10.

The tuner case 20 is formed in a structure having an accommodation space in a substantial box shape and has a substantial frame shape including the tuner module board 10 formed at an edge of the substantial box and side portions SD1, SD2. SD3, SD4 having an approximately vertical surface. The side portions SD1, SD2, SD3, SD4 of the tuner case 20 are formed by processing one plate of metal.

The top surface of the tuner case 20 has a plurality of openings facilitate work such as inspection of IC.

First, the tuner module board 10 will be described.

The tuner module board 10 has, for example, IC (circuits) 11-1 to 11-3 as terrestrial television (TV) broadcasting tuner module function units, IC (circuits) 12-1 to 12-3 as satellite broadcasting (BS) tuner module function units, and electronic components formed (mounted) on the principal surface thereof. In this example, three channels of TV and three channels of BS can simultaneously be received. The tuner module board 10 is implemented on, as an example, a circuit board 150 of a television set as shown in FIG. 5.

The tuner module board 10 is formed in a rectangular shape of a size that can be housed in an accommodation space of the tuner case 20 in a substantial box shape. The tuner module board 10 has a through hole 15 through which the core wire 36 made of metal like a blade spring of each of the antenna connectors 31, 32 is inserted is formed therein.

The tuner module board 10 has a rectangular shape and has, for example, three locked portions 13-1 to 13-3 formed on one side at an edge around the board.

The locked portions 13-1 to 13-3 of the tuner module board 10 have insertion holes through which three insertion pieces (not shown) formed on the side portion SD4 of the tuner case 20 are inserted formed therein. In this specification, various insertion pieces will be described below and the insertion piece is an example of a locking portion.

The insertion pieces provided on the side portion SD4 of the tuner case 20 are inserted into the respective insertion holes of the locked portions 13-1 to 13-3 of the tuner module board 10 and the locked portions 13-1 to 13-3 are locked by a caulking portion (not shown) or the like.

Similarly, for example, three locked portions (not shown) are formed on a side opposite to the side where the locked portions 13-1 to 13-3 of the tuner module board 10 are formed. Then, these locked portions are locked by three locking portions (not shown) formed on the side portion SD2 of the tuner case 20.

Accordingly, the tuner module board 10 is accommodated in the accommodation space of the tuner case 20 and the tuner module board 10 is made to be held in a stable position in the accommodation space of the tuner case 20.

Next, the tuner case 20 will be described.

The tuner case 20 in a state in which the tuner module board 10 is held in the accommodation space is arranged on the base 50. Support portions 52-1 to 52-7 supporting the tuner case 20 by abutting on side faces of the side portions SD1 to SD4 of the tuner case 20 are formed on four sides of the base 50.

In addition, latch portions 51-1, 51-2 are formed on the side of the base 50 corresponding to the side portion SD4 of the tuner case 20 and latch portions 51-3, 51-4 are formed on the side corresponding to the side portion SD2. Projected rim portions 28-2, 28-4 corresponding to the latch portions 51-1 to 51-4 are formed on the side portion SD4 of the tuner case 20 and the side portion SD2 also has similarly two projected rim portions (not shown) formed thereon.

Then, the base 50 is held in a stable position of the tuner case 20 by the latch portions 51-1 to 51-4 of the base 50 being latched onto the projected rim portions 28-2, 28-4, . . . .

Incidentally, the tuner case 20 has insertion pieces 20a-1 to 20a-5 at four corners of the bottom surfaces and near the center. The base 50 has insertion pieces 54-1, 54-2, . . . and notch portions 55-1, 55-2 in positions corresponding to the insertion pieces 20a-1 to 20a-5 of the tuner case 20 and the insertion pieces 20a-1 to 20a-5 are inserted into each.

The tuner case 20 has a bending portion 20A formed in the side portion SD1 as a connection portion to the antenna connectors 31, 32. A detailed description of the structure of the tuner case 20 and joining to the antenna connectors 31, 32 around a bending portion 20A will be provided later.

After the antenna connectors 31, 32 are fixed to the tuner case 20, a reinforcing member 40 is arranged like covering the top surface of the bending portion 20A. A detailed structure of the reinforcing member 40 will be described later.

Then, after the antenna connectors 31, 32 and the reinforcing member 40 are fixed to the tuner case 20, the base 50 is mounted.

Then, the cover 60 is mounted on the tuner case 20.

The cover 60 has support portions 62, . . . that support the tuner case 20 by abutting on the side portions SD2, SD4 formed thereon. In addition, latch portions 61-1, 61-2 are formed on the side of the cover 60 corresponding to the side portion SD4 of the tuner case 20 and similarly, latch portions are formed on the side corresponding to the side portion SD2. Projected rim portions 28-1, 28-3 corresponding to the latch portions 61-1, 61-2, . . . are formed on the side portion SD4 of the tuner case 20 and the side portion SD2 also has similarly two projected rim portions formed thereon.

Then, the tuner case 20 is covered with the cover 60 with stability by the latch portions 61-1, 61-2, . . . of the cover 60 being latched onto the projected rim portions 28-1, 28-3, . . . .

Next, the bending portion 20A of the tuner case 20 will be described.

Most of the whole tuner case 20 takes on a thin box shape and the connection portion of the antenna connectors 31, 32 has the bending portion 20A in a shape in which one end face of the tuner case 20 is bent.

The bending portion 20A has a vertical surface (side portion SD1) bent perpendicularly to the tuner module board 10 from one end face of the tuner case 20 and a horizontal surface 23 bent in parallel with the tuner module board 10 continuing from the side portion SD1.

The side portion SD1 (vertical surface) is formed by the horizontal surface 23 being bent from one end face of the tuner case 20 and then being bent from a portion closer to the center of the tuner case 20.

The side portion SD1 of the bending portion 20A is a joint to the antenna connectors 31, 32 and has insertion holes 21-1, 21-2 through which the core wire 36 and caulking portions 35a, 35b (example of a fixing portion) provided in the antenna connectors 31, 32 are inserted formed therein.

The width of the surface continuing from the horizontal surface 23 of the side portion SD1 is narrower than the width of a short side of four sides of the tuner case 20 and the shape thereof when viewed from the side face is convex. Notch portions 22-1, 22-2 are formed in both shoulders (portions locked onto the side portions SD2, SD4) of the surface continuing from the horizontal surface 23 of the side portion SD1. An insertion hole 24 is formed in a portion of a corner formed by the side portion SD1 of the bending portion 20A and the horizontal surface 23 and caulking portions 24a, 24b are formed at an edge of the insertion hole 24. The notch portions 22-1, 22-2, the insertion hole 24, and the caulking portions 24a, 24b are a structure into which a portion of the reinforcing member 40 is inserted for fixing.

A columnar portion 26 is formed in a portion of the horizontal surface 23 of the bending portion 20A by cutting and raising in the board direction and an insertion piece 26a is formed at the tip of the columnar portion 26. A positioning portion 25 in a convex shape is provided on the back side (board side) of the side portion SD1 of the tuner case 20. Further, two insertion holes (illustration omitted) are formed in predetermined positions of the side portion SD1 of the tuner case 20.

When the horizontal surface 23 of the bending portion 20A is formed by bending one end face of the tuner case 20 and then the side portion SD1 is formed, the tuner module board 10 is attached into the tuner case 20 in a substantial box shape. At this point, a cut portion 14 is formed in a portion abutting on the positioning portion 25 on the back surface of the side portion SD1 of the tuner module board 10 and the positioning portion 25 is inserted into the cut portion 14 for approximate positioning.

When the side portion SD1 is formed, the side portions SD2, SD4 are simultaneously bent from one end face of the tuner case 20 in a direction perpendicular to the board. The locking portions 29-4, 29-1 provided at an edge of the side portions SD2, SD4 are inserted into the corresponding insertion holes of the side portion SD1 so that the side portion SD1 is latched in a vertical state. Similarly, two insertion holes (not shown) are formed in the side portion SD3 and locking portions 29-2, 29-3 provided at an edge of the side portions SD2, SD4 are inserted into the corresponding insertion holes of the side portion SD3 so that the side portion SD3 is latched in a vertical state. At the same time, the side portions SD2, SD4 are also latched in a vertical state.

Then, simultaneous with the formation of the side portion SD1, the insertion piece 26a at the tip of the columnar portion 26 cut and raised from the horizontal surface 23 is inserted into the insertion hole formed in a position corresponding to the tuner module board 10 to fix the tuner module board 10.

By deforming the side portions of the tuner case 20 after the tuner module board 10 is inserted into the tuner case 20 as described above, the tuner module board 10 is prevented from dropping.

A portion of the high-frequency circuit connected to the IC or the like (for example, an input circuit of satellite broadcast waves and terrestrial television broadcast waves or an input/output circuit of mixed waves of satellite broadcast waves and terrestrial television broadcast waves) is arranged in the space formed by the bending portion 20A.

As shown in FIG. 2, the tuner case 20 has not only the bending portion 20A, but also the side portions SD1 to SD4 or insertion pieces (illustration omitted) of wall portions dividing the inside into a plurality of partitions (four partitions in the present example) are connected by through holes provided in the tuner module board 10 and soldering.

In the present example, the tuner case 20 is divided by wall portions into a partition in which IC 11-1, 12-1 are arranged, a partition in which IC 11-2, 12-2 are arranged, a partition in which an IC 11-3 is arranged, and a partition in which an IC 12-3 is arranged.

For the tuner case 20 in the present embodiment, a metal commonly known by nickel silver as an alloy of copper, nickel, and zinc that is a thin material and superior in solderability or tin plated copper called a tin plate is used. However, any metal superior in conductivity can generally be used for the tuner case 20 without causing any problem and thus, when constraints of the shape are not severe, an inexpensive tin plate or similar products thereof or other metals can be used.

As shown in FIG. 4, the antenna connectors 31, 32 mounted on the side portion SD1 of the tuner case 20 have the caulking portions 35a, 35b opposite to each other around the core wire 36 in the joint. The shape when viewed from the front of the joint 33 of the caulking portions 35a, 35b is circular and the shape when viewed from the side is convex. The caulking portions 35a, 35b are formed so as to extend in a direction approximately perpendicular to the tuner module board 10. That is, if a surface parallel to the tuner module board 10 is set as a reference surface (0 degree), as an example, the caulking portion 35a is arranged in a position of −180 degrees±α degrees when the antenna connector joint is viewed from the front and the caulking portion 35b is arranged in a position of 0 degree±α degrees.

Then, the caulking portions 35a, 35b are inserted into the insertion holes 21-1, 21-2 of the side portion SD1 and the caulking portions 35a, 35b are broadened to the outer side to caulk the antenna connectors 31, 32 to the side portion SD1 of the tuner case 20. With the arrangement of the caulking portions 35a, 35b with respect to the antenna connector joint, the antenna connector and the tuner case 20 are fixed with stability in a direction parallel to the tuner module board 10 and in a direction perpendicular thereto.

A tuner module in the present embodiment includes two antenna connectors, but the number thereof may naturally be one or three or more.

Next, the reinforcing member 40 will be described.

The tuner case 20 is higher than the antenna connectors 31, 32 in a contact surface with the antenna connectors 31, 32. However, the tuner case is structured to be lower than the antenna connectors 31, 32 in most of the tuner module board 10 and on the top surface of electric components such as the IC 10-1 to 11-3, 12-1 to 12-3 mounted thereon.

Thus, the reinforcing member 40 (example of the reinforcing member) having the shape (see FIG. 5) covering only the width of the core wire portion where at least the antenna connectors 31, 32 are exposed from the joint of the antenna connectors 31, 33 and the tuner case 20 is used and fixed to the tuner case 20 by caulking.

The reinforcing member 40 in the present embodiment has a step shape of about two steps corresponding to the shape of the bending portion 20A to cover the bending portion 20A and is formed by continuously bending one plate of metal vertically.

The reinforcing member 40 has a first horizontal portion 41A and a second horizontal portion 41B as surfaces parallel to the board, a first vertical portion 42A and a second vertical portion 42B as surfaces perpendicular to the board, and side face portions 43A, 43B obtained by bending the side face of the first horizontal portion 4 IA vertically.

An insertion portion 44 is formed by bending from the center of one side on the joint side of the antenna connector of the first horizontal portion 41A of the reinforcing member 40 and an opening is formed from the insertion portion 44 to the side face portions 43A, 43B. A slice portion 44a is formed in a portion of the insertion portion 44.

First, surfaces on both sides of the first horizontal portion 41A are bent vertically to form the side face portions 43A, 43B. Next, the first vertical portion 42A is bent from the first horizontal portion 41A and locked portions 47-1, 47-2 provided at ends of the side face portions 43A, 43B are inserted into insertion holes formed in corresponding positions of the first vertical portion 42A to lock the first vertical portion 42A in a state perpendicular to the first horizontal portion 41A.

Insertion pieces 46-1, 46-2 to be inserted into insertion holes formed in the tuner module board 10 are provided at ends of the side face portions 43A, 43B of the reinforcing member 40 abutting on the tuner case 20 and similarly, insertion pieces 49-1 to 49-4 are provided on the second vertical portion 42B.

The side face portions 43A, 43B of the reinforcing member 40 have cut portions 45-1, 45-2 formed at ends abutting on the tuner case 20.

The first vertical portion 42A of the reinforcing member 40 has locked portions 48-1, 48-2 projecting laterally formed at ends abutting on the tuner case 20.

To attach the reinforcing member 40 to the bending portion 20A of the tuner case 20, the insertion portion 44 of the reinforcing member 40 is inserted into the insertion hole 24 formed in the bending portion 20A and the slice portion 44a is inserted between the caulking portions 24a, 24b. The slice portion 44a of the reinforcing member 40 is caulked by the caulking portions 24a, 24b.

At the same time, the notch portions 22-1, 22-2 formed at ends of the side portion SD 1 of the tuner case 20 are inserted into the cut portions 45-1, 45-2 of the side face portions 43A, 43B of the reinforcing member 40 respectively so that the cut portions 45-1, 45-2 and the notch portions 22-1, 22-2 are engaged and fixed.

In addition, the locked portion 48-1 of the first vertical portion 42A of the reinforcing member 40 is inserted into a cut portion 27 of the side portion SD4 of the tuner case 20. Then, the locked portion 48-1 is caulked by a caulking portion 27a formed continuing from the cut portion 27 of the tuner case 20. For the locked portion 48-2 on the opposite side, the locked portion 48-2 is similarly inserted into a cut portion (not shown) of the side portion SD2 of the tuner case 20 and caulked by a caulking portion (not shown).

At this point, the insertion pieces 46-1, 46-2 of the side face portions 43A, 43B of the reinforcing member 40 and the insertion pieces 49-1 to 49-4 of the second vertical portion 42B are inserted into corresponding insertion holes of the tuner module board 10.

In this manner, the reinforcing member 40 is fixed to the bending portion 20A of the tuner case 20.

As is evident from FIGS. 2 and 3, the bending portion 20A of the tuner case 20 does not necessarily have sufficient strength in a direction perpendicular to the joint (side portion SD1) of the antenna connectors 31, 32. Arranging the reinforcing member 40 like covering the bending portion 20A has an effect of preventing the bending portion 20A from sagging and further reinforcing the strength in the twisting direction of the tuner case 20.

Sufficient strength may be obtained depending on conditions of the material or plate thickness of the tuner case 20, and in that case, the reinforcing member 40 may be omitted. By dispensing with the reinforcing member 40, the process of manufacturing the reinforcing member 40 and the process of assembling the reinforcing member 40 on the tuner case 20 can be omitted, leading to a shorter assembly time and the reduction of cost.

Incidentally, the base 50 has cut-and-raised portions 53-1 to 53-4 formed thereon and the cut-and-raised portions 53-1 to 53-4 abut on a portion (such as insertion pieces) of the tuner case 20 projected via insertion holes of the tuner module board 10. The cut-and-raised portions 53-1 to 53-4 function like a plate spring and allows a high-frequency ground potential (ground line) of the tuner module board 10 to come into contact with the base 50 in predetermined places of the tuner module board 10 with stability and also protects the tuner module board 10 from damage caused by vibration.

In the present embodiment, the tuner case 20 is structured to be able to mechanically and electrically connect to the tuner module board 10 by providing the bending portion 20A (side portion SD1) between the antenna connectors 31, 32 and the tuner case.

Accordingly, the tuner case 20 electrically connected to circuits on the tuner module board 10 to which the antenna connectors 31, 32 are connected. Generally, a tuner module in which a tuner module board is covered with a metal case has the most uniform potential in a case portion and is used by somehow connecting to a portion of the ground potential having the lowest impedance in a television set or recording device.

Therefore, the tuner case 20 is similarly grounded to the ground potential. Accordingly, circuits on the tuner module board 10 to which the antenna connectors 31, 32 are connected are separated by the bending portion 20A (side portion SD1) of the tuner case 20 having the ground potential, leading to better isolation of circuits on the tuner module board 10 to which the antenna connectors 31, 32 are connected.

For example, satellite broadcast waves and terrestrial television broadcast waves have different bands and signals can be prevented a signal from sneaking or interference outside the band from occurring. When a broadcast wave is input from one antenna connector and output from the other antenna connector to continue to connect to another device, isolation at the same frequency is improved.

In the present embodiment, a shape in which the top surface of the bending portion 20A of the tuner case 20 is covered with the reinforcing member 40 can be adopted and thus, coming noise can be removed and interference between circuits can inhibited at the same time. For example, noise mixing into a joint portion of the antenna connectors 31, 32 and the tuner module board 10 and mixing of a signal leaked out from one antenna connector into a joint portion of the other antenna connector between the two antenna connectors 31, 32 can be inhibited.

According to the present embodiment, as described above, by adopting a structure in which the reinforcing member 40 is added as a component separate from the tuner case 20 and the reinforcing member 40 is fixed to the tuner case 20 by caulking, not only mechanical strength, but also electric performance can be improved.

While the height dimension (h₁) of the joint of the antenna connectors 31, 32 remains unchanged from the conventional dimension, the corresponding portion of the antenna tuner 20 is limited to only a portion, that is, the bending portion 20A. By slimming down the tuner case 20 excluding the bending portion 20A, the height (h₂) of most of the tuner module 1 (a tuner case 20) to which the base 50 and the cover 1 are added can be designed to be lower than the height h₁ of the antenna connectors 31, 32. In the present embodiment, as shown in FIG. 5, the height h₂ of most of the tuner module 1 is lower than the height h₁ of the joint of the antenna connectors 31, 32 by a height h₃.

### 1-2. Configuration Example of Receiving Apparatus

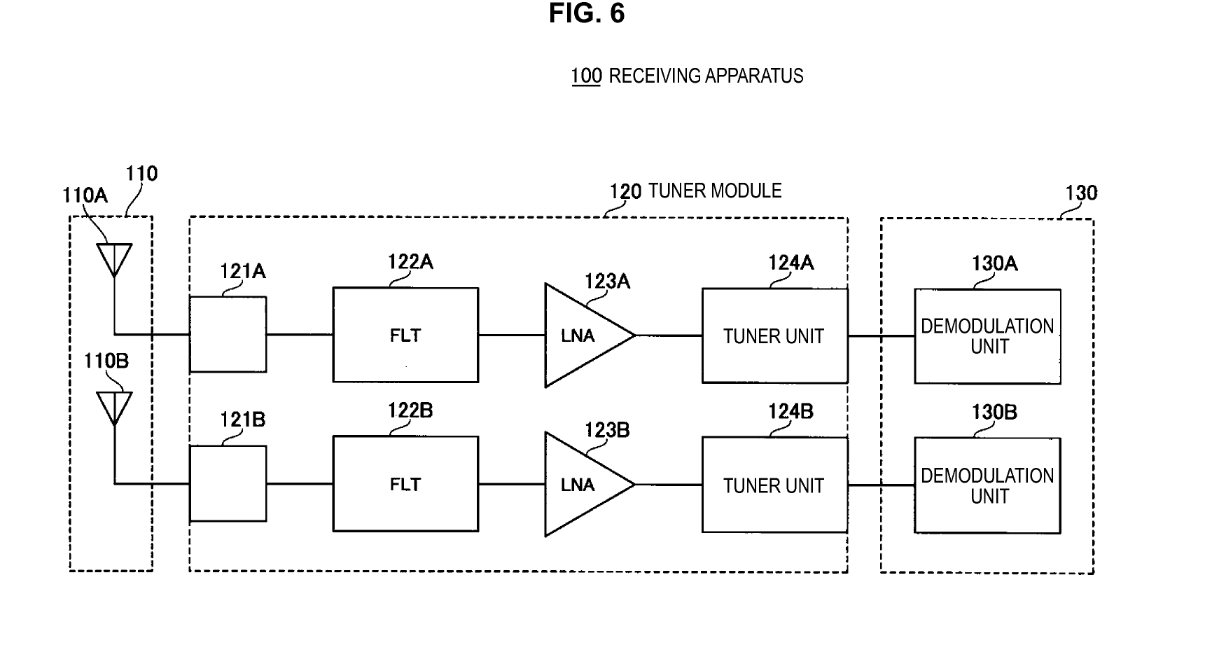

FIG. 6 is a diagram showing a configuration example of a receiving apparatus adopting the tuner module according to the present embodiment.

A receiving apparatus 100 is configured to be able to receive, for example, terrestrial television broadcast wave signals and satellite broadcast wave signals.

The receiving apparatus 100 includes, as shown in FIG. 6, a receiving antenna 110 that receives a broadcast wave signal, a tuner module 120 containing a frequency conversion function, and a demodulation unit 130. As the tuner module 120, the tuner module 1 according to the aforementioned embodiment may be adopted. The receiving apparatus 100 has two signal processing systems so that two signals of a terrestrial television broadcast wave signal and a satellite broadcast wave signal can be received. The first system is a system to receive a terrestrial television broadcast wave signal and the second system is a system to receive a satellite broadcast wave signal.

The first system of the receiving apparatus 100 includes a receiving antenna 110A, an antenna connector 121A, a filter (FLT) 122A, a low noise amplifier (LNA) 123A, a tuner unit 124A, and a demodulation unit 130A.

The second system of the receiving apparatus 100 includes a receiving antenna 110B, an antenna connector 121B, a filter (FLT) 122B, a low noise amplifier (LNA) 123B, a tuner unit 124B, and a demodulation unit 130B.

Processing units of the first system and the second system of the receiving apparatus 100 have similar functions and thus, the description will focus on the first system.

The antenna connector 121A in the first system of the receiving apparatus 100 corresponds to the antenna connector 31 of the tuner module 1.

As the filter 122A, a high-pass filter (HPF), a band-pass filter (BPF), or a low-pass filter (LPF) is appropriately applied.

The LNA 123A supplies a broadcast wave signal via the filter 122A to the tuner unit 124A.

If the received signal is a terrestrial television broadcast wave signal, the tuner unit 124A makes a frequency conversion into an intermediate-frequency signal and outputs the signal to the demodulation unit 130A. As the tuner unit 124A, the IC 11-1 to 11-3 are applied.

If the received signal is a digital terrestrial television broadcast wave signal, the demodulation unit 130A demodulates a video signal and an audio signal of an intermediate-frequency signal to generate a transport stream. If the received signal is an analog terrestrial television broadcast wave signal, the demodulation unit 130A demodulates a video signal and an audio signal of an intermediate-frequency signal to generate an analog video signal and an analog audio signal.

Difference of each processing unit of the second system of the receiving apparatus 100 from the corresponding processing unit of the first system will be described.

The antenna connector 121B in the second system of the receiving apparatus 100 corresponds to the antenna connector 32 of the tuner module 1.

If the received signal is a satellite broadcast wave signal, the tuner unit 124B makes a frequency conversion into a base-band signal and outputs the signal to the demodulation unit 130B. As the tuner unit 124B, the IC 12-1 to 12-3 are applied.

If the received signal is a satellite broadcast wave signal, the demodulation unit 130B demodulates a video signal and an audio signal of a base-band signal to generate a transport stream.

According to a receiving apparatus in the present example, the tuner module 1 according to the first embodiment is adopted and thus, excluding the joint portion (bending portion 20A) of the antenna connectors 31, 32, the whole thickness dimension when the tuner module is mounted on the circuit board 150 (see FIG. 5) as the principal surface can be limited to the same dimension as the thickness dimension of the tuner module board 10. Thus, the shape of, for example, a TV set on which the tuner module is mounted can also be slimmed down.

Therefore, the degree of freedom of arrangement in an up and down direction of, for example, an input connector exposed from a TV set to the outside is increased, which makes work of actually connecting an antenna cable easier.

In the example of FIG. 6, an example of the receiving apparatus 100 in which the processing unit is divided into two systems is described, but the processing unit of the receiving apparatus may contain only one system.

### 1-3. Example Applied to Television Set

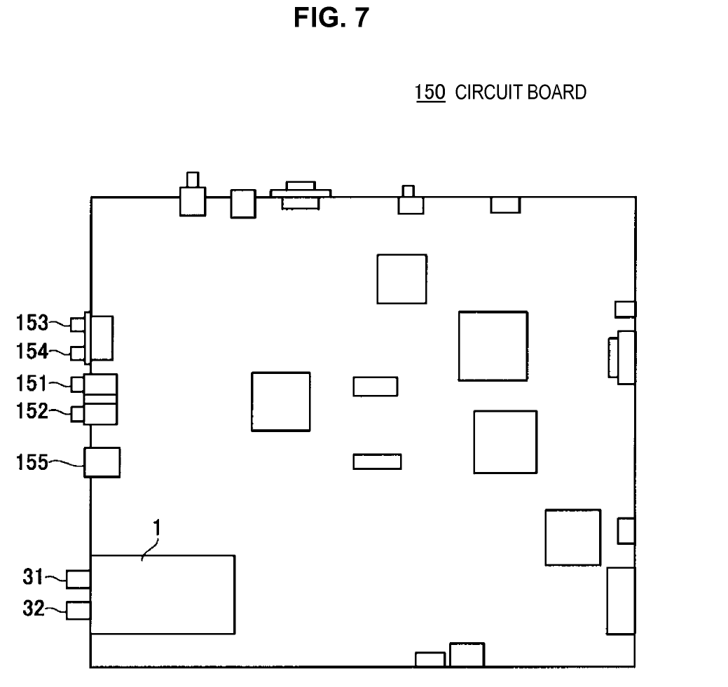

An example (application example of a receiving apparatus) in which a receiving apparatus mounted with a tuner module in the present disclosure is applied to a television set will be described with reference to FIGS. 7 to 9.

FIG. 7 is a plan view showing a configuration example of a circuit board on which the tuner module according to the present embodiment is implemented.

The circuit board 150 is an example of the circuit board for TV.

The tuner module 1 has a module configuration in which a tuner unit (IC) is accommodated in the tuner case 20 made of metal and is laid out to project to the outside in the same direction as other audio terminals (an audio input terminal 151, an audio output terminal 152), video terminals (a video input terminal 153, a video output terminal 154), and a network communication terminal 155. The tuner module 1, audio terminals, and video terminals have a so-called module structure in which circuits and terminals are aggregated and a method of mounting on the circuit board 150 handily by a process different from component implementation by a mount machine is adopted.

Because the tuner module 1, audio terminals, and video terminals are modularized and components are multi-functional and aggregated and thus, even if a component mounting method by an operator is adopted, components can be mounted in a short time and therefore, the process timeout is not seriously hindered.

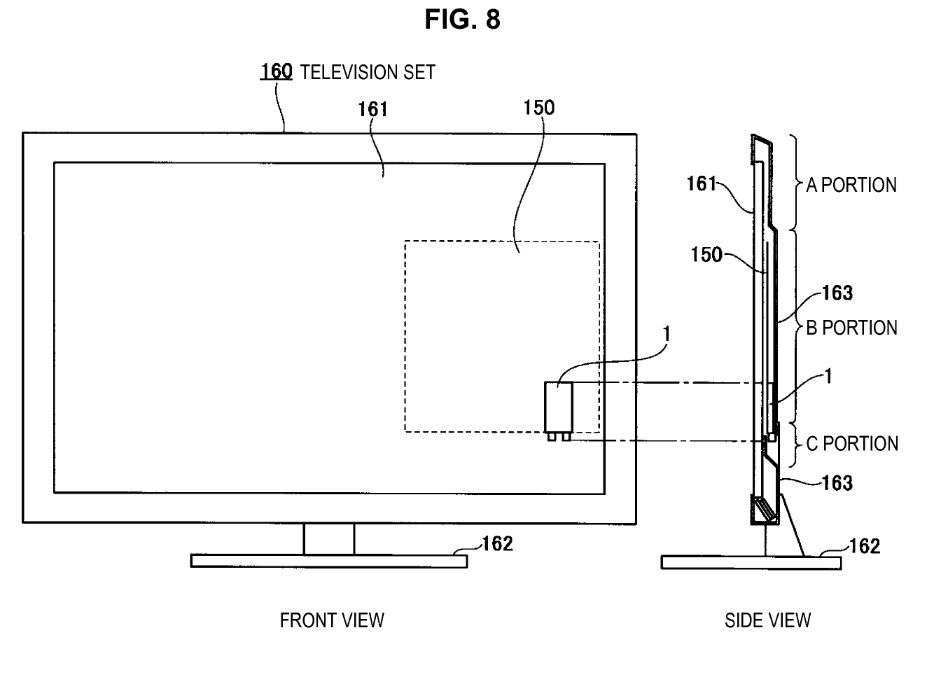

FIG. 8 is a front view and a side view of a configuration example of a television set including the circuit board on which the tuner module according to the present embodiment is implemented.

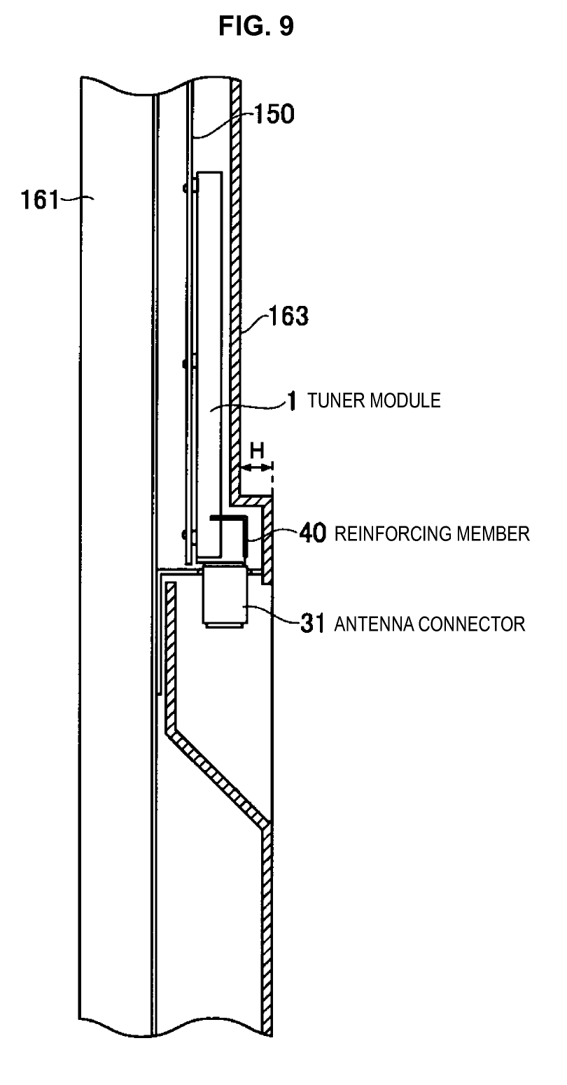

FIG. 9 is a schematic sectional view of the configuration example of the television set including the circuit board on which the tuner module according to the present embodiment is implemented.

As a display unit 161 (principal surface) of a television set 160, a flat panel display (FPD) such as a liquid crystal display and LED display is used. The screen size of the display unit 161 in the present example is set to about 40 inches, but is not limited to this example.

As is evident from the front view and the side view (perspective view) of the television set 160, the depth of the television set 160 gradually becomes thicker from the upper portion of the display unit 161 toward a stand portion 162 for reasons of its stable self-standing and stabilization of the center of gravity.

That is, elements constituting the thickness of portions containing the display unit 161 mounted inside the television set 160 are as follows:
A portion: display unit 161 (FPD)
B portion: display unit 161 (FPD)+circuit board 150
C portion: display unit 161 (FPD)+circuit board 150+connector portion

Television sets, which tend to grow in screen size, should have the center of gravity in a position as low as possible because of the danger of overturning if its mechanical center of gravity is in a high position. Thus, it is better to arrange thick components or heavy components in a lower portion of the television set.

Further, a connector portion to which a cable used for connection to the outside is connected generally has, including the antenna connectors 31, 32 according to the present embodiment, an outside diameter (height) of about 10 mm.

For accommodation in the thinnest portion (A portion: for example, 25 mm) in depth of the television set 160 on the right in FIG. 8, the total thickness of other components of only 15 mm is permitted, which is almost impossible if thinness of the body of the display unit 161 is considered.

Therefore, as shown in FIG. 9, a tuner module designed to have partially the height dimension of the connector portion (antenna connectors 31, 32) and in other portions, to be thinner than the connector portion height is favorable. In the aforementioned embodiment, the thinnest portion (height h₂) of the tuner module 1 can be minimized to about 6 mm and if arranged in a structure in which the antenna connector is disposed in the down direction of the television set 160, the structure is suitable for the design of a television set whose center of gravity is lowered and in which the depth decreases toward the upper portion thereof.

In the example shown in FIG. 9, only the height H can be made thinner by processing a back panel 163 of the television set 160. The height H corresponds to the difference h₃ between the height h₁ from the bottom of the base 50 shown in FIG. 5 up to the antenna connector 31 (32) and the height h₂ of portions other than the connector joint of the tuner module 1.

The structure of a tuner module according to the present embodiment realizes a thin type as a whole while partially increasing strength and so can suitably be applied to the structure of a slim television set, typically a television set using the current liquid crystal display panel (so-called liquid crystal TV).

In addition, according to a tuner case according to the present embodiment, the same effect as an electric outer circumferential shield case can be expected in the reinforcing member corresponding to the outermost portion in a portion where the reinforcing member covers the tuner case (bending portion), that is, in places of double metallic portions. Then, the tuner case (bending portion) therewithin can be brought into contact with a circuit board by providing a complex raised shape and thus, when, for example, a plurality of antenna input connectors is used, isolation between antenna connectors can be improved by a mechanical shield structure. At the same time, connectivity to the circuit board is increased to improve mechanical strength around the connector portion.

### 2. Second Embodiment

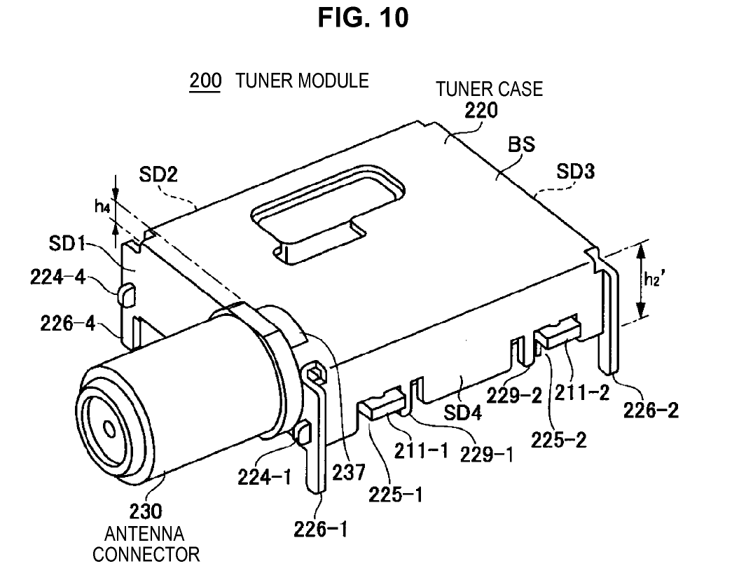

A tuner module according to the second embodiment of the present disclosure will be described with reference to FIGS. 10 to 12.

When compared with the tuner module according to the first embodiment (see FIG. 1), the second embodiment is an example having a structure in which the whole tuner case (height of the connector joint) is lower than the height (outside diameter) of an antenna connector. The second embodiment has a simple configuration in which the number of IC implemented on a tuner module board is one, no bending portion of the tuner case is provided, and none of a reinforcing member, a base, and a cover is used.

FIG. 10 is a perspective view showing a configuration example when viewed from the top surface side of a tuner module according to the second embodiment of the present disclosure.

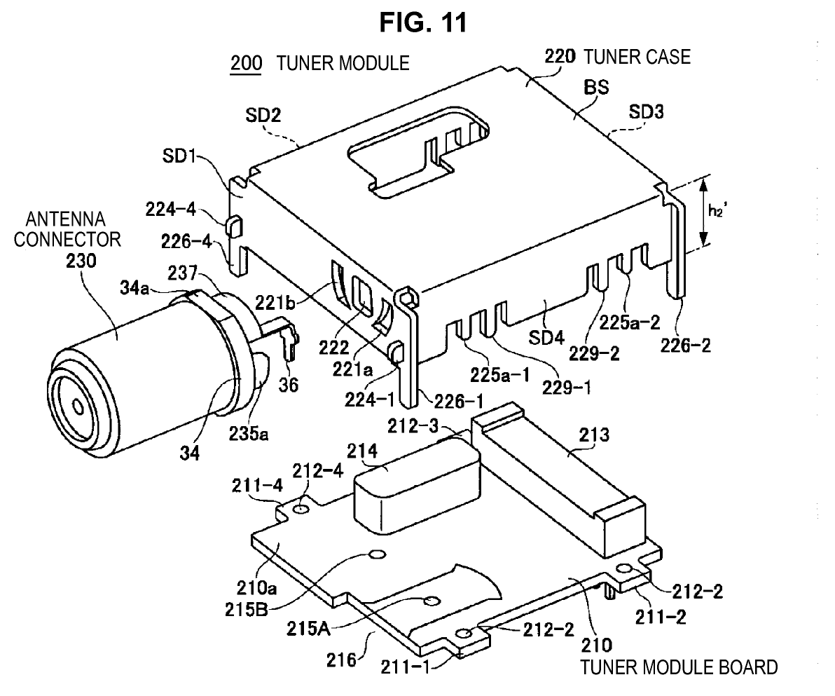

FIG. 11 is an exploded perspective view showing the configuration example when viewed from the top surface side of the tuner module according to the second embodiment of the present disclosure.

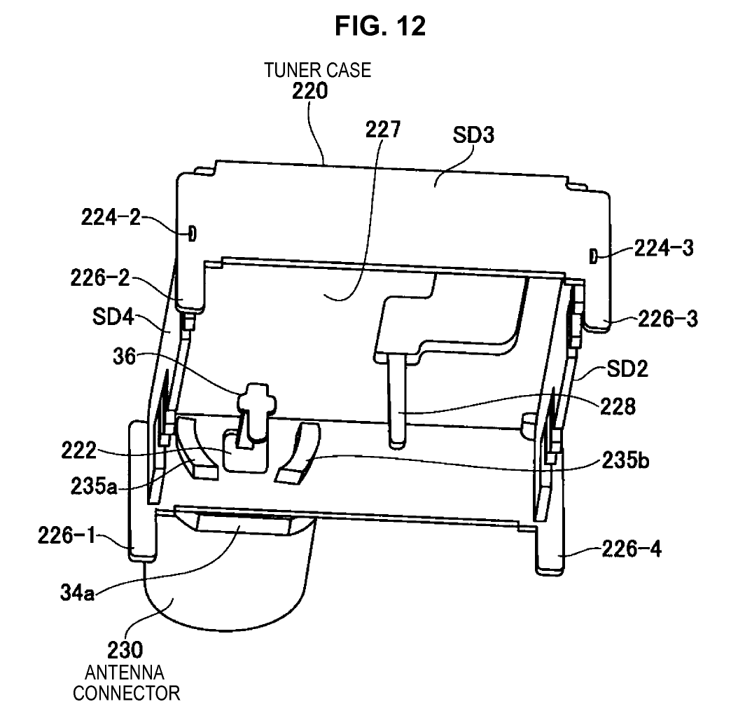

FIG. 12 is a perspective view showing the configuration example when viewed from a bottom surface side of the tuner module according to the second embodiment of the present invention.

A tuner module 200 according to the second embodiment includes a tuner module board 210 on which a tuner function unit is formed and a tuner case 220 (case body) holding the tuner module board 210 as if to contain the board and having a function as a shield case.

The tuner module 200 also includes at least one antenna connector 230 fixed to the tuner case 220 and whose core wire 36 is connected to the tuner module board 210 contained in the tuner case 220. The antenna connector 230 has an approximately cylindrical shape and an antenna cable is connected to one bottom portion and the other bottom portion (joint) is joined to the tuner case 220.

First, the tuner module board 210 will be described.

The tuner module board 210 has, for example, an IC (circuit) 213 as a television (TV) tuner module function unit and an electronic component 214 formed (mounted) on a principal surface 210a thereof. The tuner module board 210 is implemented on the circuit board 150 as shown in FIG. 7.

The tuner module board 210 is formed in a rectangular shape of the size that can be housed in an accommodation space 227 of the tuner case 220 (see FIG. 12). The tuner module board 210 has a through hole 215A through which the core wire 36 of the antenna connector 230 is inserted is formed therein.

The tuner module board 210 has, as described above, a rectangular shape and has, for example, four locked portions 211-1 to 211-4 formed on one side at an edge around the board.

The locked portions 211-1 to 211-4 are locked onto four locking portions 225-1 to 225-2, . . . formed on the side of the tuner case 220 described later in a state in which the tuner module board 210 is housed in the accommodation space 227 of the tuner case 220. Accordingly, the tuner module board 210 is made to be held in a stable position in the accommodation space 227 of the tuner case 220.

Further, the tuner module board 210 has a cut portion 216 formed at an end of the board to avoid interference between a caulking processing portion to fit the joint of the antenna connector 230 to the tuner case 220 and the tuner module board 210.

With the cut portion 216 of the tuner module board 210, the antenna connector 230 can be positioned with more stability.

The locked portions 211-1 to 211-4 of the tuner module board 210 have insertion holes 212-1, 212-2, . . . . 212-4 through which insertion pieces 225a-1, 225a-2, . . . formed the tuner case 220 are inserted formed therein.

The insertion pieces 225a-1, 225a-2, . . . are inserted into the insertion holes 212-1, 212-2, . . . , 212-4 of the tuner module board 210. Then, the tuner module board 210 is contained in the accommodation space 227 of the tuner case 220 by the locked portions 211-1 to 211-4 being locked by caulking portions 229-1, 229-2, . . . .

Next, the tuner case 220 will be described.

The tuner case 220 is formed in a rectangular paralellepiped shape of frame mold whose one surface side (bottom side) is open.

The tuner case 220 has at least the one antenna connector 230 fixed by caulking.

The tuner case 220 is formed, as will be described later, to have the thickness (height h₂′) smaller than the outside diameter of the antenna connector 230. In this case, the antenna connector 230 may be formed such that the appearance thereof is flat.

The tuner case 220 houses the tuner module board 210 in the accommodation space 227 like covering the board.

The same material as that in the first embodiment can be used for the tuner case 220 functioning as a shield case in the present embodiment.

The tuner case 220 is formed in a substantial frame shape having a rectangular basic plane portion BS having a surface parallel to the tuner module board 210 and intended to become the top surface in a fixed state and side portions SD1, SD2, SD3, SD4 formed at edges of the basic plane portion BS and having a surface approximately perpendicular to the basic plane portion BS.

The basic plane portion BS and the side portions SD1, SD2, SD3, SD4 are formed by processing one plate of metal. First, one end face of the basic plane portion BS is bent vertically to the side of the tuner module board 210 to form the side portions SD2, SD4 and next, one end face of the basic plane portion BS is bent vertically to the side of the tuner module board 210 to form the side portions SD1, SD3 to form the tuner case 220 in a substantial frame shape.

A locking portion 224-4 in a slice shape is formed at an end of the side portion SD2 abutting on the side portion SD1 and a locking portion 224-1 in a slice shape is formed at an end of the side portion SD4 abutting on the side portion SD1. When the side portion SD1 is bent toward the side of the tuner module board 210, the locking portion 224-4 of the side portion SD2 and the locking portion 224-1 of the side portion SD4 are inserted into the corresponding insertion holes to lock the side portion SD1.

Similarly, a locking portion 224-3 in a slice shape is formed at an end of the side portion SD2 abutting on the side portion SD3 and a locking portion 224-2 in a slice shape is formed at an end of the side portion SD4 abutting on the side portion SD3. When the side portion SD3 is bent toward the side of the tuner module board 210, the locking portion 224-3 of the side portion SD2 and the locking portion 224-2 of the side portion SD4 are inserted into the corresponding insertion holes to lock the side portion SD3.

A cut-and-raised portion 228 formed by cutting and raising a portion of the basic plane portion BS internally is formed in a substantial center of the basic plane portion BS (see FIG. 12). The cut-and-raised portion 228 is inserted (passed) into a through hole 215B formed in the tuner module board 210 and fixed by solder while being connected to the board ground. Incidentally, the cut-and-raised portion 228 may be provided in two places or more for the purpose of improving strength of the basic plane portion BS.

An insertion hole 222 (connector fixing portion) is formed in the side portion SD1 such that the core wire 36 of the antenna connector 230 faces the inside of the tuner case 220.

In addition, insertion holes 221a. 221b to fix the antenna connector 230 by caulking after caulking portions 235a, 235b formed on the joint of the antenna connector 230 being inserted is formed in the side portion SD1. The two caulking portions 235a, 235b are opposed to each other around the core wire 36.

The antenna connector 230 has a sandwiching portion 237 whose front side shape is circular and whose side face shape is convex with respect to the joint.

The caulking portions 235a, 235b of the antenna connector 230 has a circular shape when viewed from the front side of the joint and a convex shape when viewed from the side face thereof.

The caulking portions 235a, 235b are formed so as to extend in a direction approximately perpendicular to the tuner module board 210. That is, if a surface parallel to the tuner module board 210 is set as a reference surface (0 degree), as an example, the caulking portion 235a is arranged in a position of −180 degrees+β(2α>β) degrees when the antenna connector joint is viewed from the front and the caulking portion 235b is arranged in a position of 0 degree−β degrees. The length of the component perpendicular to the tuner module board 210 of the caulking portions 235a, 235b is formed shorter than the length of the component perpendicular to board of the caulking portions 35a, 35b of the antenna connectors 31, 32 (see FIGS. 1 to 5) according to the first embodiment.

When the antenna connector 230 is fitted to the tuner case 220 by caulking, the basic plane portion BS is sandwiched between the caulking portions 235a, 235b and the sandwiching portion 237 and the position (height) in the vertical direction of the tuner case 220 is fixed. By fixing the antenna connector 230 to the tuner case 220 using three points of the caulking portions 235a, 235b and the sandwiching portion 237, the antenna connector 230 can be prevented from rattling. Further, the antenna connector 230 can be fixed more firmly by soldering the sandwiching portion 237 of the antenna connector and the basic plane portion BS of the tuner case 220.

The locking portions 225-1, 225-2, . . . onto which the four locked portions 211-1 to 211-4 of the tuner module board 210 are locked are formed on the side portions SD2, SD4.

The four locking portions 225-1 to 225-2, . . . have the four insertion pieces 225a-1, 225a-2, . . . and the four caulking portions 229-1, 229-2, . . . and support the locked portions 211-1 to 211-4 at a predetermined height. The insertion pieces 225a-1, 225a-2, . . . and the board ground are connected by the insertion pieces 225a-1, 225a-2, . . . being guided into the insertion holes 212-1, 212-2, . . . , 212-4 of the locked portions 211-1 to 211-4.

By adopting the configuration as described above, the tuner module board 210 can be held and fixed with more stability. The configuration is the same as the structure that locks the locked portions 13-1 to 13-3 of the tuner module board 10 in the first embodiment.

Insertion pieces 226-1, 226-4 are formed on both ends of the side portion SD1 and insertion pieces 226-2, 226-3 are formed on both ends of the side portion SD3 opposite to the side portion SD. The insertion pieces 226-1 to 226-4 are inserted into the corresponding insertion holes of the circuit board 150 and the tuner case 220 is fixed to the circuit board 150 by solder or the like.

The thickness (height) of the tuner module 200 will be described.

In the present embodiment, the height h₂′ of the side portion SD1 and the opposed side portion SD3 is set such that the side portions function as support portions that support the tuner case 220 on the tuner module board 210. In the present embodiment, the height h₂′ is lower than the height (outside diameter) of the antenna connector 230.

In the first embodiment (see FIG. 5), the caulking portions 35a. 35b of the antenna connector 32 are fitted to the bending portion 20A of the tuner case 20 and has a length in the direction perpendicular to the board longer than that of the caulking portions 235a, 235b of the antenna connector 230 in the present embodiment. This also applies to the insertion holes 221a, 221b of the tuner case 220 corresponding to the caulking portions 235a, 235b. Thus, in the first embodiment, the tuner module cannot be made thinner by the height of the bending portion 20A.

In contrast, the antenna connector 230 in the present embodiment is designed such that the length in the direction perpendicular to the board of the caulking portions 235a, 235b is shorter than that of the caulking portions 35a, 35b of the antenna connector 32 and the sandwiching portion 237 (height h) abuts on the top surface of the basic plane portion BS of the tuner case 220.

Accordingly, in the present embodiment, excluding the sandwiching portion 237 (height h₄) of the antenna connector 230 positioned on the top surface of the basic plane portion BS of the tuner case 220, the top surface of the basic plane portion BS of the tuner case 220 can be configured as a planee. As a result, the whole tuner module 200 is slimmed down.

In the present embodiment, two caulking portions opposed to each other are provided on the joint of the antenna connector, but the number of caulking portions is not limited to two as long as the antenna connector is connected to the tuner case by caulking with stability and, for example, the number of caulking portions may be one.

The structure of the caulking portion and sandwiching portion of the antenna connector and the insertion hole of the tuner case in the present embodiment can be applied to the antenna connector and the bending portion of the tuner case in the first embodiment.

In the first embodiment, one large hole is formed in the tuner case as an insertion hole into which the caulking portion and core wire of the antenna connector are inserted, but also in the first embodiment, like in the second embodiment, an insertion hole may be provided in the tuner case for each of the caulking portion and the core wire of the antenna connector. In this case, even if the tuner module is slimmed down, the strength of the side portion of the tuner case can be maintained.

Conversely, in the second embodiment, like in the first embodiment, one large insertion hole into which the entire caulking portions and core wires of the antenna connectors are inserted may be provided in the tuner case. In this case, processing of the side portion of the tuner case becomes easier.

[Modification]

Next, a modification of a tuner module according to the second embodiment will be described.

The modification is a tuner module example that includes a tuner module board on which the IC (circuit) 11-1 to 11-3, 12-1 to 12-3 like in the first embodiment are implemented and to which two antenna connectors according to the second embodiment are applied. The description will be provided below by focusing differences from the first embodiment (see FIGS. 1 to 5) or the second embodiment (see FIGS. 10 to 12), for example, the joint of a tuner case and an antenna cable, the height of the tuner case, and the structure of the tuner case.

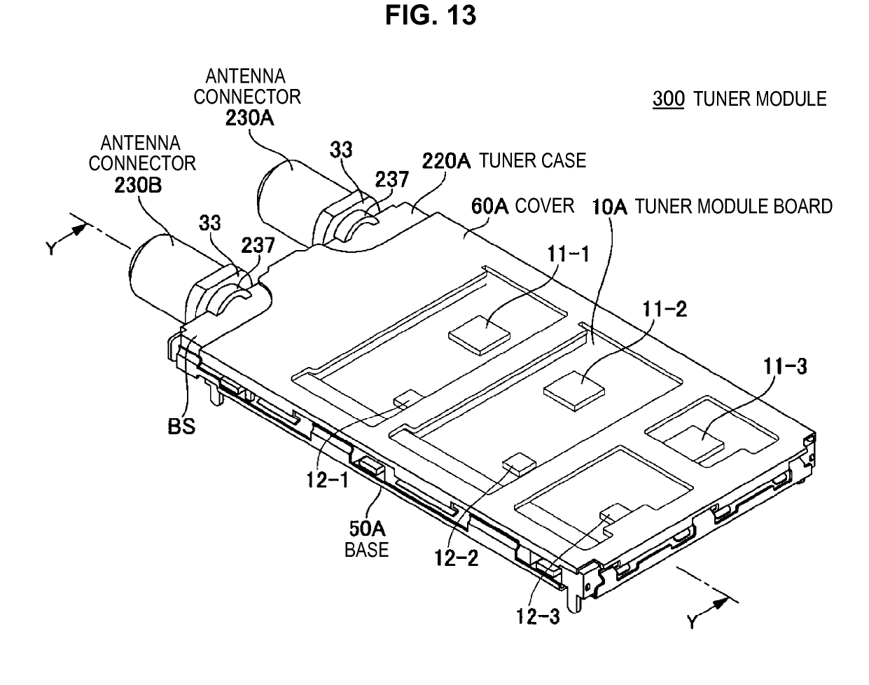

FIG. 13 is a perspective view showing a configuration example when viewed from the top surface side of a tuner module according to a modification of the second embodiment of the present disclosure.

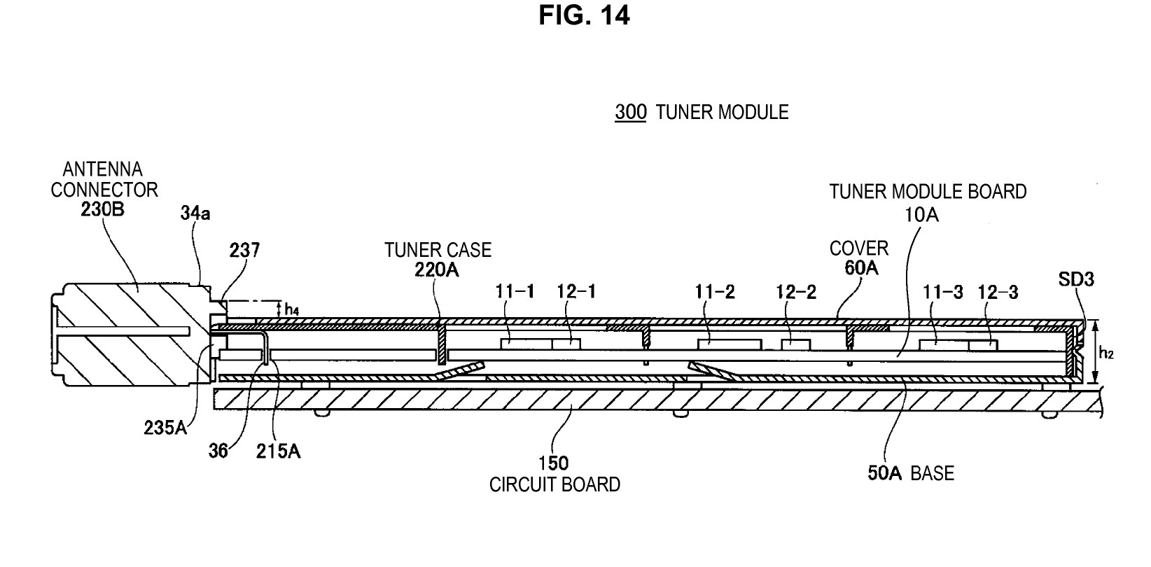

FIG. 14 is a schematic sectional view showing the configuration example of the tuner module according to the second embodiment of the present disclosure.

A tuner module 300 according to the present modification includes a tuner module board 10A including the IC (circuit) 11-1 to 11-3, 12-1 to 12-3 and on which a tuner function unit is formed and a tuner case 220A (case body) holding the tuner module board 10A as if to contain the board and having a function as a shield case.

The tuner module 300 also includes two antenna connectors 230A, 230B fixed to the tuner case 220A and whose core wire 36 is connected to the tuner module board 10A contained in the tuner case 220A. Each of the antenna connectors 230A, 230B has an approximately cylindrical shape and the same structure as that of the antenna connector 230.

The tuner case 220A is arranged on a base 50A and an upper portion thereof is covered with a cover 60A as a structure to protect the tuner module board 10A.

Excluding the joint portion to the antenna connector, the tuner case 220A has approximately the same structure as that of the tuner case 220 (see FIG. 1).

The base 50A has approximately the same structure as that of the base 50.

The cover 60A has approximately the same structure as that of the cover 60. The cover 60A has a large plane portion covering the tuner case 220A. In the example of FIG. 13, the cover 60A is depicted as a transparent cover and holes for IC circuits of the tuner case 220A below the cover are visible.

The joining form of the tuner case 220A and the joint 33 of the antenna connector 230B is the same as that of the tuner case 220 and the joint 33 of the antenna connector 230B shown in FIGS. 10 to 12. This also applies to the antenna connector 230A.

When the antenna connector 230B is fitted to the tuner case 220A by caulking, the basic plane portion BS of the tuner case 220A is sandwiched between the caulking portions 235a, 235b and the sandwiching portion 237 and the position (height) in the vertical direction of the tuner case 220A is fixed. By fixing the antenna connector 230B to the tuner case 220A using three points of the caulking portions 235a. 235b and the sandwiching portion 237, the antenna connector 230B can be prevented from rattling. Further, the antenna connector 230B can be fixed more firmly by soldering the sandwiching portion 237 of the antenna connector and the basic plane portion BS of the tuner case 220A.

The antenna connectors 230A, B in the present embodiment is designed such that, as described above, the length in the direction perpendicular to the board of the caulking portions 235a, 235b is shorter than that of the caulking portions 35a, 35b (see FIG. 5) according to the first embodiment and the sandwiching portion 237 (height h₄) protrudes from the basic plane portion BS of the tuner case 220A.

Therefore, excluding the sandwiching portion 237 (height h₄) of the antenna connector 230B positioned on the top surface of the basic plane portion BS of the tuner case 220A, most of the basic plane portion BS of the tuner case 220A can be configured as a plane. That is, the thickness (height) of most of the tuner module 300 can be made as high as the thinnest portion (height h₂) of the tuner module 1. As a result, when compared with the first embodiment, the tuner module 300 as a whole can be slimmed down. The effect of slimming down manifests itself conspicuously when the tuner module 300 is incorporated into the set side of the television set 160 or the like.

The tuner module according to the modification of the second embodiment shown in FIGS. 13 and 14 includes two antenna connectors, but may naturally include one or three or more antenna connectors.

Incidentally, the structure of the caulking portion and sandwiching portion of the antenna connector and the insertion hole of the tuner case in the first embodiment and the second embodiment described above are assumed to be circular, but each portion may have other shapes such as a linear shape if fixed with stability by caulking. The method of fixing an antenna connector to a tuner case is not limited to caulking and fixing by solder or both may also be used.

Additionally, the present technology may also be configured as below.

(1)

A tuner module including:

a tuner module board on which a tuner function unit is formed;

a case body that holds at least the tuner module board so as to contain the board; and

at least one antenna connector fixed to the case body and whose core wire is connected to the tuner module board contained in the case body,

wherein a fixing portion and a sandwiching portion in a convex shape are formed on a joint of the antenna connector to the case body,

wherein the case body has at least a horizontal surface and a vertical surface with respect to the tuner module board, and the vertical surface has one insertion hole or more into which the core wire and the fixing portion of the antenna connector are inserted, and

wherein, when the core wire and the fixing portion of the antenna connector are inserted into the insertion hole of the case body, a portion on the vertical surface of the case body between the insertion hole and the horizontal surface is sandwiched between the fixing portion and the sandwiching portion of the antenna connector.

(2)

The tuner module according to (1), wherein the two fixing portions opposite to each other around the core wire are formed on the joint of the antenna connector.

(3)

The tuner module according to (1) or (2),

wherein the fixing portion and the sandwiching portion formed on the joint of the antenna connector have a circular shape when viewed from a front side of the joint.

(4)

The tuner module according to any one of (1) to (3),

wherein the case body is formed in a frame shape having
a basic plane portion parallel to the tuner module board and formed as the horizontal surface and
a side portion as the vertical portion formed perpendicularly to an edge of the basic plane portion, and

wherein the side portion is formed with a height lower than the height of the antenna connector.

(5)

The tuner module according to any one of (1) to (3).

wherein the case body
has a bending portion in which a side portion is formed as the vertical surface by being bent vertically with respect to the tuner module board from one end face of the case body, and
is formed with a height of portions of the case body other than the bending portion lower than the height of the side portion of the bending portion.
   (6)

The tuner module according to claim 5, further including: a base on which the case body is arranged and to which a ground line of the tuner module board is connected.

(7)

The tuner module according to (6), further including:

a reinforcing member formed by fitting to the shape of the bending portion of the case body to cover the bending portion,

wherein a locking portion is formed at an end of the reinforcing member abutting on the case body, and the reinforcing member is locked onto the case body by the locking portion.

(8)

The tuner module according to any one of (1) to (7).

wherein the case body is formed of a metal having conductivity.

(9)

A tuner module including:

a tuner module board on which a tuner function unit is formed;

a case body that holds at least the tuner module board so as to contain the board; and

at least one antenna connector fixed to the case body and whose core wire is connected to the tuner module board contained in the case body,

wherein a fixing portion in a convex shape is formed on a joint of the antenna connector to the case body,

wherein the case body has at least a horizontal surface and a vertical surface with respect to the tuner module board, and the vertical surface has one insertion hole or more into which the core wire and the fixing portion of the antenna connector are inserted, and

wherein the core wire and the fixing portion of the antenna connector are inserted into the insertion hole of the case body, and the fixing portion of the antenna connector is caulked by the insertion hole formed on the vertical surface of the case body.

(10)

A receiving apparatus including:

a tuner module including
a tuner module board on which a tuner function unit is formed,
a case body that holds at least the tuner module board so as to contain the board, and
at least one antenna connector fixed to the case body and whose core wire is connected to the tuner module board contained in the case body; and

a circuit board on which the tuner module is implemented.

wherein a fixing portion and a sandwiching portion in a convex shape are formed on a joint of the antenna connector to the case body,

wherein the case body has at least a horizontal surface and a vertical surface with respect to the tuner module board, and the vertical surface has one insertion hole or more into which the core wire and the fixing portion of the antenna connector are inserted, and

wherein, when the core wire and the fixing portion of the antenna connector are inserted into the insertion hole of the case body, a portion on the vertical surface of the case body between the insertion hole and the horizontal surface is sandwiched between the fixing portion and the sandwiching portion of the antenna connector.

(11)

A receiving apparatus including:

a tuner module including
a tuner module board on which a tuner function unit is formed,
a case body that holds at least the tuner module board so as to contain the board, and
at least one antenna connector fixed to the case body and whose core wire is connected to the tuner module board contained in the case body,

wherein a fixing portion in a convex shape is formed on a joint of the antenna connector to the case body,

wherein the case body has at least a horizontal surface and a vertical surface with respect to the tuner module board, and the vertical surface has one insertion hole or more into which the core wire and the fixing portion of the antenna connector are inserted, and

wherein the core wire and the fixing portion of the antenna connector are inserted into the insertion hole of the case body and the fixing portion of the antenna connector is caulked by the insertion hole formed on the vertical surface of the case body.

The present disclosure is not limited to each of the aforementioned embodiments and other various modifications and application examples can naturally be developed without deviating from the spirit described in claims.

That is, examples of each of the aforementioned embodiments are preferred concrete examples of the present disclosure and thus, various restrictions that are technically preferable are imposed. However, the technical scope of the present disclosure is not limited to such forms if restrictions of the present disclosure are not specifically mentioned in each description. For example, used materials and amounts of use thereof, treatment times, treatment order, and numerical conditions for each parameter mentioned in the following description are only preferred examples and dimensions, shapes, and arrangement relations in each diagram used for the description are schematic.

### REFERENCE SIGNS LIST

1 tuner module
10, 10A tuner module board
20 tuner case
20A bending portion
20a-1 to 20a-5 insertion piece
21-1, 21-2 insertion hole
22-1, 22-2 notch portion
23 horizontal surface
24 insertion hole
24a, 24b caulking portion
25 positioning portion
26 columnar portion
27 cut portion
27a caulking portion
31, 32 antenna connector
33 joint
34 flange portion
34a flat portion
35a. 35b caulking portion
36 core wire
40 reinforcing member
41A first horizontal portion
41B second horizontal portion
42A first vertical portion
42B second vertical portion
43A, 43B side face portion
44 insertion portion
44a slice portion
45-1, 45-2 cut portion
46-1, 46b-1 insertion piece
47-1, 47-2 locked portion
48-1, 48-2 locked portion
49-1 to 49-4 insertion piece
50, 50A base
60, 60A cover
100 receiving apparatus
120 tuner module
150 circuit board
160 television set
200 tuner module
210 tuner module board
211-1 to 211-4 locked portion
212-1 to 212-4 insertion hole
220, 220A tuner case
221a. 221b insertion hole
222 insertion hole
225-1 to 225-2 locking portion
225a-1 to 225a-2 insertion piece
226-1 to 226-4 insertion piece
227 accommodation space
229-1 to 229-2 caulking portion
230, 230A, 230B antenna connector
235a to 235b caulking portion
237 sandwiching portion
300 tuner module
SD1 to SD4 side portion
BS basic plane portion

1. A tuner module comprising:
a tuner module board on which a tuner function unit is formed;
a case body that holds at least the tuner module board so as to contain the board: and
at least one antenna connector fixed to the case body and whose core wire is connected to the tuner module board contained in the case body,
wherein a fixing portion and a sandwiching portion in a convex shape are formed on a joint of the antenna connector to the case body,
wherein the case body has at least a horizontal surface and a vertical surface with respect to the tuner module board, and the vertical surface has one insertion hole or more into which the core wire and the fixing portion of the antenna connector are inserted, and
wherein, when the core wire and the fixing portion of the antenna connector are inserted into the insertion hole of the case body, a portion on the vertical surface of the case body between the insertion hole and the horizontal surface is sandwiched between the fixing portion and the sandwiching portion of the antenna connector.

2. The tuner module according to claim 1,
wherein the two fixing portions opposite to each other around the core wire are formed on the joint of the antenna connector.

3. The tuner module according to claim 2,
wherein the fixing portion and the sandwiching portion formed on the joint of the antenna connector have a circular shape when viewed from a front side of the joint.

4. The tuner module according to claim 3,
wherein the case body is formed in a frame shape having
a basic plane portion parallel to the tuner module board and formed as the horizontal surface and
a side portion as the vertical portion formed perpendicularly to an edge of the basic plane portion, and
wherein the side portion is formed with a height lower than the height of the antenna connector.

5. The tuner module according to claim 3,
wherein the case body
has a bending portion in which a side portion is formed as the vertical surface by being bent vertically with respect to the tuner module board from one end face of the case body, and
is formed with a height of portions of the case body other than the bending portion lower than the height of the side portion of the bending portion.

6. The tuner module according to claim 5, further comprising:
a base on which the case body is arranged and to which a ground line of the tuner module board is connected.

7. The tuner module according to claim 6, further comprising:
a reinforcing member formed by fitting to the shape of the bending portion of the case body to cover the bending portion,
wherein a locking portion is formed at an end of the reinforcing member abutting on the case body, and the reinforcing member is locked onto the case body by the locking portion.

8. The tuner module according to claim 4,
wherein the case body is formed of a metal having conductivity.

9. A tuner module comprising:
a tuner module board on which a tuner function unit is formed;
a case body that holds at least the tuner module board so as to contain the board; and
at least one antenna connector fixed to the case body and whose core wire is connected to the tuner module board contained in the case body,
wherein a fixing portion in a convex shape is formed on a joint of the antenna connector to the case body,
wherein the case body has at least a horizontal surface and a vertical surface with respect to the tuner module board, and the vertical surface has one insertion hole or more into which the core wire and the fixing portion of the antenna connector are inserted, and
wherein the core wire and the fixing portion of the antenna connector are inserted into the insertion hole of the case body, and the fixing portion of the antenna connector is caulked by the insertion hole formed on the vertical surface of the case body.

10. A receiving apparatus comprising:
a tuner module including
a tuner module board on which a tuner function unit is formed,
a case body that holds at least the tuner module board so as to contain the board, and
at least one antenna connector fixed to the case body and whose core wire is connected to the tuner module board contained in the case body; and
a circuit board on which the tuner module is implemented,
wherein a fixing portion and a sandwiching portion in a convex shape are formed on a joint of the antenna connector to the case body,
wherein the case body has at least a horizontal surface and a vertical surface with respect to the tuner module board, and the vertical surface has one insertion hole or more into which the core wire and the fixing portion of the antenna connector are inserted, and
wherein, when the core wire and the fixing portion of the antenna connector are inserted into the insertion hole of the case body, a portion on the vertical surface of the case body between the insertion hole and the horizontal surface is sandwiched between the fixing portion and the sandwiching portion of the antenna connector.

11. A receiving apparatus comprising:
a tuner module including
a tuner module board on which a tuner function unit is formed,
a case body that holds at least the tuner module board so as to contain the board, and
at least one antenna connector fixed to the case body and whose core wire is connected to the tuner module board contained in the case body,
wherein a fixing portion in a convex shape is formed on a joint of the antenna connector to the case body,
wherein the case body has at least a horizontal surface and a vertical surface with respect to the tuner module board, and the vertical surface has one insertion hole or more into which the core wire and the fixing portion of the antenna connector are inserted, and
wherein the core wire and the fixing portion of the antenna connector are inserted into the insertion hole of the case body and the fixing portion of the antenna connector is caulked by the insertion hole formed on the vertical surface of the case body.
